(19) United States
(12) Patent Application Publication
(10) Pub. No.: US 2008/0024526 A1
(43) Pub. Date: Jan. 31, 2008

(54) ORGANIC LIGHT EMITTING DIODE DISPLAY AND DRIVING METHOD THEREOF

(76) Inventors: Chun-Seok KO, Hwaseong-si (KR); Byung-Sik Koh, Gwangmyeong-si (KR); Si-Duk Sung, Seoul (KR)

Correspondence Address: MACPHERSON KWOK CHEN & HEID LLP, 2033 GATEWAY PLACE, SUITE 400, SAN JOSE, CA, 95110, US

(21) Appl. No.: 11/770,512

(22) Filed: Jun. 28, 2007

(30) Foreign Application Priority Data
Jul. 28, 2006 (KR) 10-2006-0071315

(51) Int. Cl. G09G 5/10; G09G 3/00; G09G 3/32

(52) U.S. Cl. 345/690; 315/169.1; 345/82

(57) ABSTRACT

An organic light emitting diode (OLED) display and a method of driving the same are provided. The OLED display includes: a plurality of pixels arrayed in a matrix, each of which includes a switching transistor and a driving transistor; a plurality of data lines connected to the switching transistors, which transmit a data voltage to the pixels; a plurality of driving voltage lines that transmit a driving voltage to the driving transistors; a voltage generator that applies the driving voltage to the driving voltage lines; a current sensing unit that senses a driving current that flows from the voltage generator to the driving voltage lines; a gray voltage generator that generates a gray voltage depending on a change in the driving current; and a data driver that converts an input image signal into the data voltage on the basis of the gray voltage and applies the data voltage to the data lines.

### CROSS-REFERENCE TO RELATED APPLICATION

This application claims priority to and the benefit of Korean Patent Application No. 10-2006-0071315 filed in the Korean Intellectual Property Office on Jul. 28, 2006, the entire contents of which are incorporated herein by reference.

### BACKGROUND OF THE INVENTION

(a) Field of the Invention

The present invention relates to a display device and a driving method thereof. More particularly, the present invention relates to an organic light emitting diode (OLED) display and a driving method thereof.

(b) Description of the Related Art

Recently, an organic light emitting diode (OLED) display in addition to a liquid crystal display (LCD) has been spotlighted as a flat panel display. An active matrix OLED display includes organic light emitting diodes (OLEDs) and driving thin film transistors (TFTs) for supplying a current to the OLEDs.

The thin film transistors are classified into polysilicon thin film transistors and amorphous silicon thin film transistors according to types of active layers. Due to various advantages, the OLED display employing the polysilicon thin film transistors have been generally used. However, manufacturing processes for the thin film transistors are complex, and thus, manufacturing uniformity decreases. By using the OLED display employing the amorphous silicon thin film transistors, a large screen can be easily obtained. In addition, the number of production processes thereof is relatively less than that of the OLED display employing the polysilicon thin film transistors.

However, a positive voltage is continuously applied to control terminals of the driving TFTs, and accordingly a threshold voltage increases when the TFTs are amorphous silicon TFTs. When the threshold voltage increases, even though the same control voltage is applied, a current driven by the TFTs decreases, and accordingly luminance of the OLED also decreases.

In addition, since performance of the OLED deteriorates due to long time use, even when the same driving current is applied, the luminance of the OLED decreases.

Various pixel circuits for compensating the luminance decrease due to the performance deterioration of the driving TFTs and the OLEDs have been suggested. However, since most of the pixel circuits generally include TFTs, capacitors, and wiring, the aperture ratio of each pixel is low.

### SUMMARY OF THE INVENTION

The present invention has been made in an effort to provide an organic light emitting diode (OLED) display having advantages of increasing a lifetime of a display device by compensating for a luminance decrease with respect to passage of time without decreasing the aperture ratio of the OLED display.

According to an aspect of the present invention, there is provided an OLED display including: a plurality of pixels arrayed in a matrix, each of which includes a switching transistor and a driving transistor; a plurality of data lines connected to the switching transistors, which transmit a data voltage to the pixels; a plurality of driving voltage lines that transmit a driving voltage to the driving transistors; a voltage generator that applies the driving voltage to the driving voltage lines; a current sensing unit that senses a driving current that flows from the voltage generator to the driving voltage lines; a gray voltage generator that generates a gray voltage depending on a change in the driving current; and a data driver that converts an input image signal into the data voltage on the basis of the gray voltage and applies the data voltage to the data lines.

In the above aspect of the present invention, the OLED display may further include a signal controller that calculates a change in the driving current by comparing data corresponding to the driving current with data corresponding to a reference current and controls the gray voltage generator on the basis of the change in the driving current.

In addition, the signal controller may control the gray voltage generator to maintain the level of the reference gray voltage when the driving current is measured.

The signal controller may control the gray voltage generator to set the reference gray voltage to an initial value when the driving current is measured.

The current sensing unit may include an analog-to-digital converter that converts a signal related to the driving current into a digital value and transmits the digital value to the signal controller.

The driving current may be measured when the same data voltage is applied to the plurality of pixels.

The data voltage may be a data voltage corresponding to a predetermined gray.

The predetermined gray may be the highest gray or an intermediate gray.

The driving current may be measured immediately after the OLED display is turned on or off.

The driving current may be calculated for an input image signal corresponding to each of three colors.

The three colors may be red, green, and blue.

As the change in the driving current increases, the reference gray voltage increases.

According to another aspect of the present invention, there is provided a method of driving an OLED display including a plurality of pixels arrayed in a matrix, a plurality of driving voltage lines connected to the pixels, and a voltage generator that applies a driving voltage to the driving voltage lines, the method including steps of measuring a driving current that flows between the voltage generator and the driving voltage lines, calculating a current change by comparing the driving current with a reference current, and generating a reference gray voltage according to the current change.

In the above aspect of the present invention, as the current change increases, the reference gray voltage increases.

In addition, the driving current may be measured immediately after the OLED display is turned on or off.

The driving current may be measured when the same data voltage is applied to the plurality of pixels.

The data voltage may be a data voltage corresponding to the highest gray or an intermediate gray.

### BRIEF DESCRIPTION OF THE DRAWINGS

Now, the above and other features and advantages of the present invention will become more apparent by describing in detail exemplary embodiments thereof with reference to the attached drawings, in which:

FIG. 1 is a block diagram illustrating an organic light emitting diode (OLED) display according to an embodiment of the present invention;

FIG. 2 is an equivalent circuit diagram illustrating a pixel of an OLED display according to an embodiment of the present invention;

FIG. 3 is a graph illustrating an example of a reference gray voltage that is output from a gray voltage generator of an OLED display according to an embodiment of the present invention;

FIG. 4 illustrates an example of a gray voltage generator of an OLED display according to an embodiment of the present invention; and

FIG. 5 is a waveform diagram illustrating a driving signal of the gray voltage generator shown in FIG. 4.

### DETAILED DESCRIPTION OF THE EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

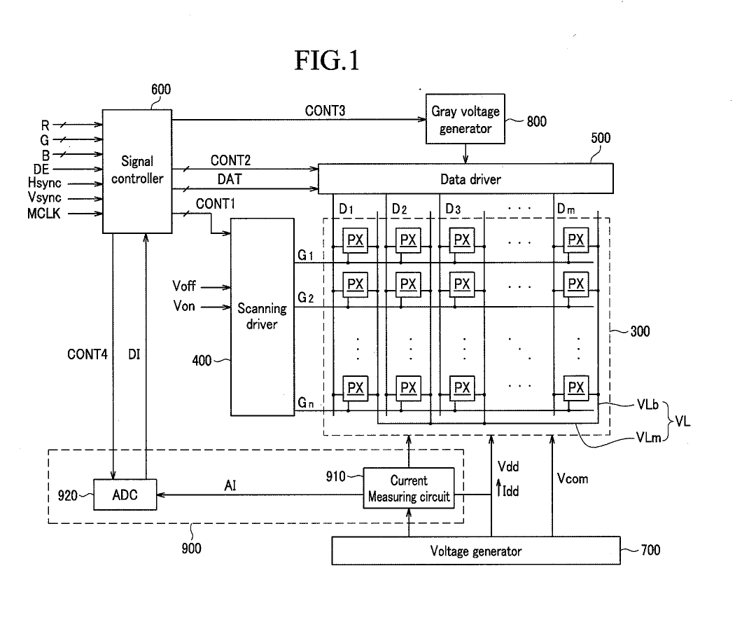

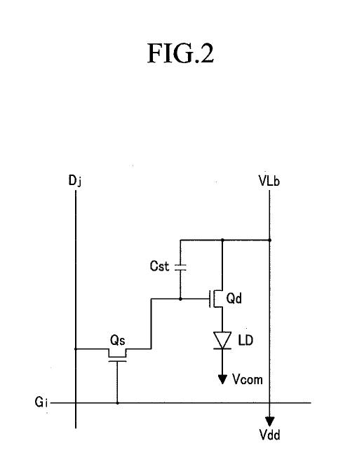

First, an organic light emitting diode (OLED) display according to an embodiment of the present invention will be described with reference to FIGS. 1 and 2.

FIG. 1 is a block diagram illustrating an organic light emitting diode (OLED) display according to an embodiment of the present invention, and FIG. 2 is an equivalent circuit diagram illustrating a pixel of an OLED display according to an embodiment of the present invention.

As shown in FIG. 1, the OLED display according to the embodiment of the present invention includes a display panel 300, a scanning driver 400, a data driver 500, a voltage generator 700, a gray voltage generator 800, a current sensing unit 900, and a signal controller 600.

The display panel 300 includes a plurality of signal lines G₁ to Gₙ and D₁ to Dₘ, a plurality of driving voltage lines VL, and a plurality of pixels PXs that are connected to the signal lines G₁ to Gₙ and D₁ to Dₘ and the driving voltage lines VL and arrayed substantially in a matrix.

The signal lines include a plurality of scanning signal lines G₁ to Gₙ that transmit scanning signals and a plurality of data lines D₁ to Dₘ that transmit data voltages. The scanning signal lines G₁ to Gₙ extend substantially in the row direction substantially parallel to each other. The data lines D₁ to Dₘ extend substantially in the column direction substantially parallel to each other.

The driving voltage lines VL extend substantially in a column direction and transmit a driving voltage Vdd.

As shown in FIG. 2, each of the pixels PX, for example a pixel PX connected to the i-th scanning signal line Gᵢ and the j-th data line Dⱼ, includes an organic light emitting device LD, a driving transistor Qd, a storage capacitor Cst, and a switching transistor Qs.

The switching transistor Qs includes a control terminal, an input terminal, and an output terminal. The control terminal is connected to the scanning signal line Gᵢ, the input terminal is connected to the data line Dⱼ, and the output terminal is connected to the driving transistor Qd. The switching transistor Qs transmits the data voltage that is applied to the data line Dⱼ in response to the scanning signal that is applied to the scanning signal line Gᵢ.

Similarly, the driving transistor Qd includes a control terminal, an input terminal, and an output terminal. The control terminal is connected to the switching transistor Qs, the input terminal is connected to the branch lines VLb of the driving voltage line VL, and the output terminal is connected to the organic light emitting device LD. The driving transistor Qd allows an output current I_{LD} that is dependent on the voltage applied between the control and output terminals of the driving transistor Qd to flow.

The storage capacitor Cst is connected between the control and input terminals of the driving transistor Qd. The storage capacitor Cst is charged by the data voltage applied to the control terminal of the driving transistor Qd and maintained after the switching transistor Qs is turned off.

The organic light emitting device LD is an OLED, and includes an anode connected to the output terminal of the driving transistor Qd and a cathode connected to the common voltage Vcom. The anode may be a pixel electrode (not shown) substantially located in the region partitioned by two scanning signal lines G₁ to Gₙ and two data lines D₁ to Dₘ. The cathode may be a part of a common electrode (not shown) disposed over the entire surface of the display panel 300. The organic light emitting device LD displays an image by emitting light depending on the current I_{LD} output from the driving transistor Qd.

The organic light emitting device LD may display one of primary colors or display one of the primary colors and white. The primary colors may be three primary colors such as red, green, and blue. A desired color is displayed by a spatial sum of the primary colors. Alternatively, the organic light emitting devices LDs of all the pixels PXs can display white, and some pixels PXs may further include color filters (not shown) for converting white light emitted from the organic light emitting device LD into one of the primary colors.

The switching transistor Qs and the driving transistor Qd are n-channel field effect transistors (FETs) made of amorphous silicon or polysilicon. Alternatively, at least one of the switching transistor Qs and the driving transistor Qd may be a p-channel field effect transistor. The switching transistor Qs, the driving transistor Qd, the storage capacitor Cst, and the organic light emitting device LD may be connected in different ways.

Referring to FIG. 1 again, the gray voltage generator 800 generates a plurality of reference gray voltages related to the luminance of the pixels PXs. The number of reference gray voltages is less than that of the entire grays. The reference voltages change with respect to time, and reflect a compensation value for the luminance decrease of the display device according to a control of the signal controller 600.

The scanning driver 400 applies the scanning signal obtained from the combination of a high voltage Von connected to the scanning signal lines G₁ to Gₙ of the display panel 300 to turn on the switching transistor Qs and a low voltage Voff connected to the scanning signal lines G₁ to Gₙ of the display panel 300 to turn off the switching transistor Qs to the scanning signal lines G₁ to Gₙ.

The data driver 500 is connected to the data lines D₁ to Dₘ of the display panel 300. The data driver 500 generates the data voltage by dividing the reference gray voltage supplied by the gray voltage generator 800 and applies the data voltage to the data lines D₁ to Dₘ.

The voltage generator 700 is connected to the driving voltage lines VL of the display panel 300. The voltage generator 700 generates the driving voltage Vdd and applies the driving voltage Vdd to the driving voltage lines VL. In addition, the voltage generator 700 applies the common voltage Vcom to the display panel 300.

The current sensing unit 900 senses the driving current Idd that flows between the voltage generator 700 and the driving voltage line VL. The current sensing unit 900 includes a current measuring circuit 910 and an analog-to-digital converter (ADC) 920.

The current measuring circuit 910 measures the driving current Idd that flows from the voltage generator 700 to the driving voltage line VL and generates an analogue current measuring signal AI corresponding to the driving current Idd. The analog current measuring signal AI generated by the current measuring circuit 910 may be a voltage signal. The current measuring circuit 910 may be directly connected to the driving voltage line VL to measure the current that flows through the driving voltage line VL.

The ADC 920 converts the analog current measuring signal AI received from the current measuring circuit 910 into the digital current measuring signal DI.

The signal controller 600 controls the scanning driver 400, the data driver 500, the gray voltage generator 800, the current sensing unit 900, and the like.

Each of the driving devices 400 to 900 may be integrated into the liquid crystal panel 300 together with the signal lines G₁ to Gₙ and D₁ to Dₘ, the thin film transistor, and the switching element. Unlike this, the driving devices 400 to 900 may be directly mounted on the display panel 300 in a form of at least one IC chip, may be attached to the display panel 300 in a form of a tape carrier package (TCP) in which the driving devices 400 to 900 are mounted on a flexible printed circuit film (not shown), or may be mounted on a separate printed circuit board (PCB) (not shown). Alternatively, the driving devices 400 to 900 may be integrated into a single chip. In this case, at least one of the driving devices 400 to 900 or at least one circuit element that constitutes the driving devices 400 to 900 may be located outside the single chip.

Hereinafter, a display operation of the OLED display will be described in detail.

The signal controller 600 receives input image signals R, G, and B and input control signals for controlling display of the input image signals R, G, and B from an external graphics controller (not shown). The input image signals R, G, and B include luminance information of each pixel PX. The luminance information includes a predetermined number, for example 1024 (=2¹⁰), 256 (=2⁸) or 64 (=2⁶), of grays. Examples of the input control signal are a vertical synchronizing signal Vsync, a horizontal synchronizing signal Hsync, a main clock signal MCLK, a data enable signal DE, and so forth.

The signal controller 600 processes the input image signals R, G, and B on the basis of the input image signals R, G, and B and the input control signals to satisfy operating conditions of the display panel 300, and generates an output image signal DAT, a scanning control signal CONT1, a data control signal CONT2, a gray voltage control signal CONT3, a current sensing control signal CONT4, and so forth. The signal controller 600 outputs the scanning control signal CONT1 to the gray voltage generator 800, outputs the gray voltage control signal CONT3 to the gray voltage generator 800, outputs the current sensing control signal CONT4 to the current sensing unit 900, and outputs the data control signal CONT2 and an output image signal DAT to the data driver 500.

The scanning control signal CONT1 includes a scanning start signal STV for instructing the high voltage Von to start scanning and at least one clock signal for controlling an output period of the high voltage Von. The scanning control signal CONT1 may further include an output enable signal OE for limiting duration of the gate-on voltage Von.

The data control signal CONT2 includes a horizontal synchronizing start signal STH for indicating the start of the transmission of the digital image data DAT of pixels PXs of a row, a load signal LOAD for instructing the image data signal to be applied to the image data lines D₁ to Dₘ, and a data clock signal HCLK.

The gray voltage control signal CONT3 includes gamma data, which is a digital signal, and gives information needed for generating the reference gray voltage.

The gray voltage generator 800 generates the reference gray voltage according to the gray voltage control signal CONT3 and supplies the reference gray voltage to the data driver 500.

According to the data control signal CONT2 from the signal controller 600, the data driver 500 receives the output image data DAT of pixels PXs of a row, generates the analog data voltage corresponding to the output image data DAT by dividing the reference gray voltage, and applies the analog data voltage to the corresponding data lines D₁ to Dₘ.

The scanning driver 400 converts the scanning signal applied to the scanning signal lines G₁ to Gₙ into the high voltage Von according to the scanning control signal CONT1 from the signal controller 600. Accordingly, the switching transistor Qs connected to the scanning signal lines G₁ to Gₙ is turned on, and the data voltage applied to the data lines D₁ to Dₘ is applied to the control terminal of the driving transistor Qd in the corresponding pixel PX.

The storage capacitor Cst is charged by the data voltage applied to the driving transistor Qd, and the charged voltage is maintained even when the switching transistor Qs is turned off. The driving transistor Qd supplied with the data voltage is turned on to output the current I_{LD} dependent on the data voltage. Then, the organic light emitting device LD emits light depending on the magnitude of the driving current I_{LD}, and accordingly the corresponding pixel PX displays an image.

The data driver 500 and the scanning driver 400 repeat the aforementioned procedures for the pixels of the next row after one horizontal period (or “1H”, which is one period of the horizontal synchronizing signal Hsync and the data enable signal DE). The data voltage is applied to all the pixels PXs by sequentially applying the scanning signal to all the scanning signal lines G₁ to Gₙ for one frame in the aforementioned manner. The next frame is started after one frame is ended. The same operations are repeated in the next frame.

On the other hand, the output current I_{LD} of the driving transistor Qd flows from the branch line VLb of the driving voltage line VL to the common voltage Vcom. Accordingly, the current Idd (hereinafter referred to as the driving current) that flows from the voltage generator 900 to the driving voltage line VL is generated. As the performance of the driving transistor Qd deteriorates due to long time use, the output current I_{LD} of the driving transistor Qd decreases, and accordingly the driving current I_{LD} also decreases. Thus, when the change in the driving current I_{LD} is given, the degree of degradation of the driving transistor Qd can be obtained.

In the present embodiment, the magnitude of the data voltage applied to the pixel PX is changed by measuring the driving current I_{LD} and correcting the reference gray voltage generated by the gray voltage generator 800 on the basis of the measured driving current I_{LD}. Accordingly, the output current I_{LD} of the driving transistor Qd is the same with respect to the same input image signals R, G, and B, and the luminance of the organic light emitting device LD is also the same with respect to the same input image signals R, G, and B.

Hereinafter, a procedure of compensating the reference gray voltage will be described in detail.

First, the current measuring circuit 910 measures the driving current Idd that flows between the voltage generator 900 and the driving voltage line VL.

The driving current Idd may start to be measured after a predetermined time has elapsed since the OLED display was used. The driving current Idd may also start to be measured immediately after the OLED display is turned on or off. Alternatively, the driving current I_{LD} may be measured when the same voltage is applied to all the pixels PXs. At this time, the data voltage may be a data voltage corresponding to a predetermined gray, that is to say, the highest gray or an intermediate gray. When the same data voltage is applied to all the pixels PXs, a defective image is displayed. However, since the OLED display does not display a normal image immediately after the OLED display is turned on or off, displaying the defective image immediately after the OLED display is turned on or off does not influence display of images.

The aforementioned operation for measuring the driving current I_{LD} is performed by the signal controller 600. For example, when the signal controller 600 receives a switch on/off signal for turning on/off the OLED display by a user, the signal controller 600 cuts off the image signals R, G, and B that are input from outside of the signal controller 600 and transmits the output image signal DAT with a predetermined gray to the data driver 500. Simultaneously, the signal controller 600 enables the current sensing unit 900 to sense the driving current I_{LD} by using the current sensing control signal CONT4.

The current measuring circuit 910 generates the analog current measuring signal AI corresponding to the measured driving current Idd and outputs the analog current measuring signal AI to the ADC 920. Then, the ADC 920 converts the analog current measuring signal AI into the digital current measuring signal DI and outputs the digital current measuring signal DI to the signal controller 600.

The signal controller 600 compares the digital current measuring signal DI received from the ADC 920 with the previously stored reference data and changes the gamma data that is the gray voltage control signal CONT3 according to the comparison result. For example, the signal controller 600 obtains the difference between the digital current measuring signal DI and the reference data and changes the gamma data according to the difference.

Here, the reference data may be a digital value obtained by measuring the driving current Idd when the OLED display is firstly used and converting the driving current Idd into the digital current measuring signal DI. Alternatively, the reference data may be a value that is previously determined in manufacturing procedures depending on product characteristics of the OLED display.

The gray voltage generator 800 changes the reference gray voltage that is supplied to the data driver 500 according to the gamma data from the signal controller 600, and accordingly, the data voltage generated by the data driver 500 is also changed.

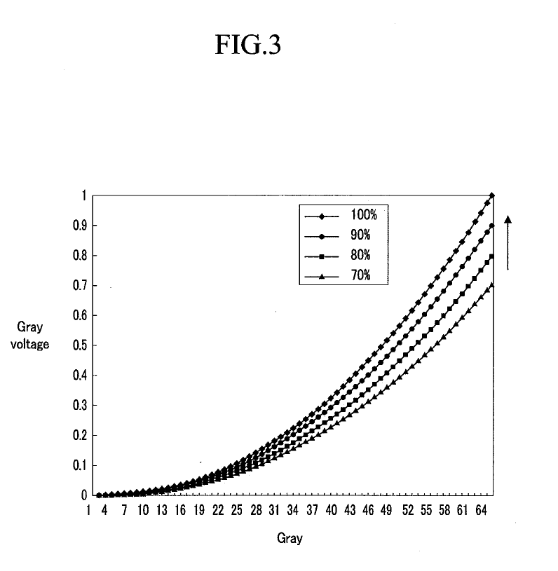

Hereinafter, an example of a reference gray voltage of an OLED display according to an embodiment of the present invention will be described in detail with reference to FIG. 3.

FIG. 3 is a graph illustrating an example of a gray voltage of an OLED display according to an embodiment of the present invention as a function of gray.

Referring to FIG. 3, the x-axis represents 64 grays from the first gray to the 64th gray, and the y-axis represents a gray voltage normalized between 0 and 1. The reference gray voltage generated by the gray voltage generator 800 according to an embodiment of the present invention may be a gray voltage with respect to several grays among the entire grays.

The gray voltage may be determined along a 70% curve when the OLED display is firstly used. According to the 70% curve, the reference gray voltage at the 64th gray that is the highest gray is 0.7.

As the OLED display is used for a long time, the driving current I_{LD} is decreased. Accordingly, the level of the reference gray voltage is increased to an 80% curve, to a 90% curve, and finally to a 100% curve.

Similarly, the higher the level of the reference gray voltage is, the higher the level of the data voltage with respect to the same gray is. At this time, when the level of the reference gray voltage is adjusted so that the same driving current Idd flows with respect to the same gray, the same luminance can be maintained with respect to the same gray.

For example, when the driving current Idd is measured, the signal controller 600 can set all the reference gray voltages to initial values by controlling the gray voltage generator 800. Then, the signal controller 600 transmits the predetermined gray image signal to the data driver 500 and allows the pixels PXs to emit light, thereby measuring the driving current Idd. The difference between the digital current measuring signal DI and the reference data reflects the absolute degree of the performance deterioration of the driving transistor Qd. Accordingly, the signal controller 600 searches a lookup table (not shown) for the gamma data corresponding to the difference between the measured signal DI and the reference data and transmits the gamma data to the gray voltage generator 900, thereby correcting the reference gray voltage.

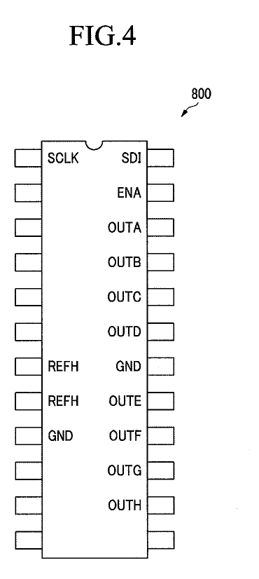

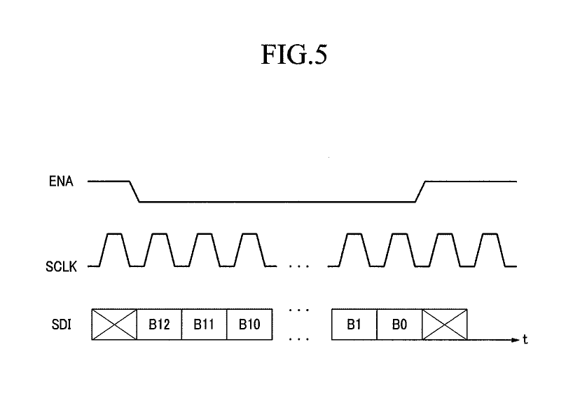

Alternatively, the signal controller 600 may maintain the level of the reference gray voltage generated by the gray voltage generator 800 when the driving current Idd is measured. For example, even when the reference gray voltage has been previously corrected, the status of the reference gray voltage is maintained. Then, the data voltage applied to each pixel PX is a corrected value to some extent. The difference between the digital current measuring signal DI and the reference data reflects the degree of performance deterioration of the driving transistor Qd on the basis of the previously corrected status, instead of the absolute performance deterioration of the driving transistor Qd. In this case, the compensation is performed by increasing the reference gray voltage until the digital current measuring signal DI becomes the same as the reference data. Now, an example of a gray voltage generator of an OLED display according to an embodiment of the present invention will be described in detail with reference to FIGS. 4 and 5.

FIG. 4 illustrates an example of an IC chip in which a gray voltage generator of an OLED display according to an embodiment of the present invention is embodied. FIG. 5 is a waveform diagram illustrating a driving signal of the gray voltage generator shown in FIG. 4.

Referring to FIG. 4, the chip of the gray voltage generator 800 according to an embodiment of the present invention includes a serial clock terminal SCLK into which a clock signal is input, reference voltage input terminals REFH and REFL, a ground terminal GND, a serial data input terminal SDI into which a serial data input signal is input, and enable terminal ENA into which an enable signal is input, eight reference gray voltage output terminals OUTA, OUTB, OUTC, OUTD, OUTE, OUTF, OUTG, and OUTH, and so forth.

The reference voltage input terminals REFH and REFL are supplied with the ground voltage and the reference voltages V_{REFH} and V_{REFL} that are criteria for determining the reference gray voltage. The reference voltages V_{REFH} and V_{REFL} are a pair of high and low reference voltages V_{REFH} and V_{REFL}.

The serial data input signal SDI is data that includes information needed for generating the reference gray voltage. The serial data input signal SDI is generally supplied from the signal controller 600. The serial data input signal SDI may include three bits for determining the output terminal of the reference gray voltage and ten bits for determining the value of the reference gray voltage. The serial data input signal SDI may further include a digital signal for controlling an operation of the gray voltage generator 800.

Table 1 is a table illustrating the operation of the gray voltage generator shown in FIG. 4. Table 1 will be described together with FIGS. 4 and 5.

TABLE 1

| OUTPUT LOCATION | | | GAMMA DATA | | | | | | | | | | |
|---|---|---|---|---|---|---|---|---|---|---|---|---|---|
| A2 | A1 | A0 | D9 | D8 | D7 | D6 | D5 | D4 | D3 | D2 | D1 | D0 | RESULT |
| 0 | 0 | 0 | 0 | 0 | 0 | 0 | 0 | 0 | 0 | 0 | 0 | 0 | OUT A, |
| | | | | | | | | | | | | | DECIMAL |
| | | | | | | | | | | | | | GAMMA |
| | | | | | | | | | | | | | DATA = 0 |
| 0 | 0 | 0 | 1 | 1 | 1 | 1 | 1 | 1 | 1 | 1 | 1 | 1 | OUT A, |
| | | | | | | | | | | | | | DECIMAL |
| | | | | | | | | | | | | | GAMMA |
| | | | | | | | | | | | | | DATA = 1023 |
| 0 | 0 | 0 | 1 | 0 | 0 | 0 | 0 | 0 | 0 | 0 | 0 | 0 | OUT A, |
| | | | | | | | | | | | | | DECIMAL |
| | | | | | | | | | | | | | GAMMA |
| | | | | | | | | | | | | | DATA = 512 |
| 0 | 1 | 1 | 0 | 0 | 0 | 0 | 0 | 0 | 0 | 0 | 0 | 1 | OUT C, |
| | | | | | | | | | | | | | DECIMAL |
| | | | | | | | | | | | | | GAMMA |
| | | | | | | | | | | | | | DATA = 513 |
| 1 | 1 | 1 | 0 | 0 | 0 | 0 | 0 | 1 | 1 | 1 | 1 | 1 | OUT H, |
| | | | | | | | | | | | | | DECIMAL |
| | | | | | | | | | | | | | GAMMA |
| | | | | | | | | | | | | | DATA = 31 |
| 1 | 1 | 1 | 0 | 0 | 0 | 0 | 0 | 1 | 1 | 1 | 1 | 1 | OUT H, |
| | | | | | | | | | | | | | DECIMAL |
| | | | | | | | | | | | | | GAMMA |
| | | | | | | | | | | | | | DATA = 31 |

The serial data input signal SDI is valid when the enable signal ENA is at a low level.

The 12th, 11th, and 10th bits B12, B11, and B10 of the serial data input signal SDI in FIG. 5 are represented as A2, A1, and A0 in Table 1. The 12th, 11th, and 10th bits B12, B11, and B10 of the serial data input signal SDI determine the output terminal of the reference gray voltage. For example, as shown in Table 1, when A2, A1, and A0 are 0, 0, and 0, the output terminal of the reference gray voltage is designated to the first output terminal OUTA. When A2, A1, and A0 are 0, 1, and 1, the output terminal of the reference gray voltage is designated to the third output terminal OUTC. When A2, A1, and A0 are 1, 1, and 1, the output terminal of the reference gray voltage is designated to the eighth output terminal OUTH.

The 9th to 0th bits B9 to B0 of the serial data input signal SDI in FIG. 5 are represented as D9 to D0 in Table 1. The 9th to 0th bits B9 to B0 of the serial data input signal SDI indicate binary gamma data GAMMA DATA for determining the value of the output reference gray voltage. The binary gamma data is transformed into a decimal number, for example 0000000000 is transformed into 0, 1111111111 is transformed into 1023, 1000000000 is transformed into 512, 1000000001 is transformed into 513, and 0000011111 is transformed into 31.

The gray voltage generator 800 calculates the reference gray voltage by inputting the gamma data GAMMA DATA into Equation 1 and outputs the reference gray voltage through the corresponding terminal OUTA, OUTB, OUTC, OUTD, OUTE, OUTF, OUTG, or OUTH.

$${V}_{OUT} = {V}_{REFL} + \frac{GAMMADATA}{1024} \times ( {V}_{REFH} - {V}_{REFL} ) \qquad ( Equation 1 )$$

Here, V_{OUT} is the reference gray voltage that is output through the reference gray voltage output terminal OUTA, OUTB, OUTC, OUTD, OUTE, OUTF, OUTG, or OUTH.

According to an embodiment of the present invention, the lifetime of the display device is increased by compensating luminance with respect to time without decreasing the aperture ratio of the OLED display.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An OLED (organic light emitting diode) display comprising:
a plurality of pixels arrayed in a matrix, each of which comprises a switching transistor and a driving transistor;
a plurality of data lines connected to the switching transistors, which transmit a data voltage to the pixels;
a plurality of driving voltage lines that transmit a driving voltage to the driving transistors;
a voltage generator that applies the driving voltage to the driving voltage lines;
a current sensing unit that senses a driving current that flows from the voltage generator to the driving voltage lines;
a gray voltage generator that generates a gray voltage depending on a change in the driving current; and
a data driver that converts an input image signal into the data voltage based on the gray voltage and applies the data voltage to the data lines.

2. The OLED display of claim 1, further comprising a signal controller that calculates the change of the driving current by comparing data corresponding to the driving current with data corresponding to a reference current and controls the gray voltage generator on the basis of the change of the driving current.

3. The OLED display of claim 2, wherein the signal controller controls the gray voltage generator to maintain a level of the reference gray voltage when the driving current is measured.

4. The OLED display of claim 2, wherein the signal controller controls the gray voltage generator to set the reference gray voltage to an initial value when the driving current is measured.

5. The OLED display of claim 2, wherein the current sensing unit comprises an analog-to-digital converter that converts a signal related to the driving current into a digital value and transmits the digital value to the signal controller.

6. The OLED display of claim 2, wherein the driving current is measured when the same data voltage is applied to the pixels.

7. The OLED display of claim 6, wherein the data voltage is a data voltage corresponding to a predetermined gray.

8. The OLED display of claim 7, wherein the predetermined gray is the highest gray or an intermediate gray.

9. The OLED display of claim 2, wherein the driving current is measured immediately after the OLED display turns on or off.

10. The OLED display of claim 2, wherein the driving current is calculated for an input image signal corresponding to each of three colors.

11. The OLED display of claim 10, wherein the three colors are red, green, and blue.

12. The OLED display of claim 1, wherein as the change in the driving current increases, the reference gray voltage increases.

13. A method of driving an OLED display comprising a plurality of pixels arrayed in a matrix, a plurality of driving voltage lines connected to the pixels, and a voltage generator that applies a driving voltage to the driving voltage lines, the method comprising steps of:
measuring a driving current that flows between the voltage generator and the driving voltage lines;
calculating a current change by comparing the driving current with a reference current; and
generating a reference gray voltage according to the current change.

14. The method of claim 13, wherein as the current change increases, the reference gray voltage increases.

15. The method of claim 13, wherein the driving current is measured immediately after the OLED display is turned on or off.

16. The method of claim 15, wherein the driving current is measured when the same data voltage is applied to the plurality of pixels.

17. The method of claim 15, wherein the data voltage is a data voltage corresponding to the highest gray or an intermediate gray.
